(19) United States
(12) Patent Application Publication
(10) Pub. No.: US 2008/0097937 A1
(43) Pub. Date: Apr. 24, 2008

(54) Distributed method for integrating data mining and text categorization techniques

(76) Inventor: Ali Hadjarian, Burke, VA (US)

Correspondence Address: SEYFARTH SHAW LLP, 131 S. DEARBORN ST., SUITE 2400, CHICAGO, IL, 60603-5803, US

(21) Appl. No.: 11/904,674

(22) Filed: Sep. 28, 2007

Related U.S. Application Data
(63) Continuation-in-part of application No. 10/616,718, filed on Jul. 10, 2003, now Pat. No. 7,308,436.
(60) Provisional application No. 60/848,092, filed on Sep. 29, 2006.

(51) Int. Cl. G06F 15/18

(52) U.S. Cl. 706/12

(57) ABSTRACT

A method for prediction analysis using text categorization is provided. The method includes the steps of: grouping a plurality of text documents into a plurality of classes; selecting a top m most discriminatory terms for each class of documents using statistical based measures; determining for each document the presence or absence of each of the discriminatory terms; learning rule-based models of each class of documents using a rule learning algorithm; determining, for at least a portion of the plurality of documents, if a given learned rule has been satisfied by each respective document; creating a database of the rules associated with documents satisfying the rules; and performing distributed data mining to form a predictive result based on at least a portion of the plurality of documents.

### CROSS-REFERENCE TO RELATED APPLICATION

This present application claims priority to U.S. Provisional Patent Application Ser. No. 60/848,092, to Hadjarian, filed Sep. 29, 2006, entitled “INFERTEXT: A DISTRIBUTED FRAMEWORK FOR INTEGRATING DATA MINING AND TEXT CATEGORIZATION TECHNIQUES.” The present application is also a continuation-in-part of U.S. application Ser. No. 10/616,718, filed Jul. 10, 2003, entitled “DISTRIBUTED DATA MINING AND COMPRESSION METHOD AND SYSTEM.”

### FIELD OF THE INVENTION

This invention relates generally to a method for Integrating Predictive Analytics and Text Categorization techniques within a distributed machine learning framework.

### BACKGROUND

Recent years have seen a significant surge of interest in the application of mining algorithms to unstructured data. This stems from the general realization that the true potentials of mining applications can only be actualized with the ability to tap into the vast amounts of unstructured data, 85% of all data according to some estimates.

Most algorithms designed for the processing of unstructured data are loosely coined as text mining algorithms. These include Information Extraction and Text Categorization algorithms, among others. While there is often a well established link between Information Extraction and data mining, the application of Text Categorization in a data mining context is much less prevalent.

In a typical text mining application, an Information Extraction (IE) algorithm (such as described in Done, J., Gerstl, P. and Seiffert, R. (1999), Text mining: finding nuggets in mountains of textual data, in Proceedings of ACM SIGKDD International Conference on Knowledge Discovery and Data Mining (San Diego, Calif., 1999), 398-401; Pazienza, Maria Teresa (1999), Information Extraction: Towards Scalable, Adaptable Systems, Springer; and Knight, Kevin (1999). Mining Online Text. Communications of the ACM 42(11): 586) is first used to populate structured data tables with data elements extracted from unstructured data collections. A data mining algorithm is then applied to the structured data in order to find patterns of potential interest to the user. So this form of text mining can easily facilitate the integration of structured and unstructured data sources. A popular form of IE is that of Entity Extraction, intended at extracting such information as the names of people, organizations, and places from the documents.

Text Categorization (TC) (such as described in Sebastiani, Fabrizio (2002), Machine learning in automated text categorization, ACM Computing Surveys, 34(1): 1-47; Joachims, T. (1998), Text categorization with Support Vector Machines: Learning with many relevant features, In Machine Learning: ECML-98, Tenth European Conference on Machine Learning, pp. 137-142; Koller, D., Sahami, M. (1997), Hierarchically classifying documents using very few words, Proc. of the 14th International Conference on Machine Learning ICML 97, pp. 170-178; Lewis, D., D. Stern and A. Singhal (1999), ATTICS: A Software Platform for Online Text Classification, SIGIR '99; and Hadjarian, Ali, Jerzy W. Bala, Peter Pachowicz (2001), Text Categorization through Multistrategy Learning and Visualization, In Proceedings of Conference on Intelligent Text Processing and Computational Linguistics (CICLing) 2001: 437-443) on the other hand is generally not intended for explicit discovery of new knowledge from unstructured data. (see Hearst, M. (1999). Untangling text data mining. Proceedings of ACL '99: the 37th Annual Meeting of the Association for Computational Linguistics). Instead, it is designed to build classifiers that automatically assign unstructured data (e.g. text documents) to predefined categories. As such, the terms Text Categorization and text classification are often used interchangeably. Since the ultimate aim of such a classifier is simply assigning classes (e.g. topical labels) to various data points, the human comprehensibility aspect of the generated models is generally not of much concern. As such, most text classifiers use a black-box approach to modeling, i.e. what is of essence is the input to and the output of the classifier and not so much the intermediate representations of object classes.

### SUMMARY

In one form, a method for prediction analysis using text categorization is provided. The method includes the steps of: grouping a plurality of text documents into a plurality of classes; selecting a top m most discriminatory terms for each class of documents using statistical based measures; determining for each document the presence or absence of each of the discriminatory terms; learning rule-based models of each class of documents using a rule learning algorithm; determining, for at least a portion of the plurality of documents, if a given learned rule has been satisfied by each respective document; creating a database of the rules associated with documents satisfying the rules; and performing distributed data mining to form a predictive result based on at least a portion of the plurality of documents.

According to one form, a method for prediction analysis using text categorization is provided. The method includes the steps of: providing a structured data table having a plurality of class labels; grouping a plurality of text documents into classes based on the class labels; selecting a top m most discriminatory terms having the highest calculated fitness measure for each class of documents; determining for each document the presence or absence of each of the discriminatory terms; determining a concept for each class, the concept being associated with the respective class; determining, for at least a portion of the plurality of documents, if a given concept is associated with each respective document; forming a numeric vector for each document indicating if the document is associated with each respective concept; creating a structured data table of the vectors; and performing distributed data mining on the structured data table to form a predictive result.

In one form, a method for prediction analysis using text categorization is provided. The method includes the steps of: providing a structured data table having a plurality of class labels; grouping a plurality of text documents into classes based on the class labels; selecting a top m most discriminatory terms having the highest calculated fitness measure for each class of documents; determining for each document the presence or absence of each of the discriminatory terms; determining at least one concept for each class, the concept being associated with the respective class; determining, for at least a portion of the plurality of documents, if a given concept is associated with each respective document; creating a database of the concepts and the associated documents; and performing distributed data mining on the database to form a predictive result.

According to one form, the method further includes the step of representing each document in terms of a numeric vector indicating the presence or absence of the discriminatory terms.

In one form, the plurality of text documents are from an unstructured database.

According to one form, the method further includes the step of representing each document in terms of a numeric vector indicating whether a learned rule has been satisfied by the document.

In one form, the step of performing data mining includes utilizing a decision tree to form the predictive result.

According to one form, the step of performing data mining includes the steps of: collecting candidate attributes by a mediator from a plurality of agents; selecting a winning agent; initiating data splitting by the winning agent; forwarding split data index information from the winning agent to the mediator; forwarding the split data index information from the mediator to each of the agents; and initiating data splitting by each of the agents other than the winning agent.

In one form, a system for prediction analysis using text categorization is provided. The system includes at least one memory unit and a plurality of processing units. The plurality of processing units grouping a plurality of text documents into a plurality of classes, selecting a top m most discriminatory terms for each class of documents using statistical based measures, determining for each document the presence or absence of each of the discriminatory terms, learning rule-based models of each class of documents using a rule learning algorithm, determining, for at least a portion of the plurality of documents, if a given learned rule has been satisfied by each respective document, creating a database of the rules associated with documents satisfying the rules and performing distributed data mining to form a predictive result based on at least a portion of the plurality of documents.

Other forms are also contemplated as understood by those skilled in the art.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its constructions and operation, and many of its advantages should be readily understood and appreciated.

FIG. 1 is a diagrammatic representation of one form of a method for text mining;

FIG. 2 is a diagrammatic representation of one form of a concept extraction process;

FIG. 3 is a diagrammatic representation of one form of a feature selection process;

FIG. 4 is a diagrammatic representation of one form of a vector space;

FIG. 5 is a diagrammatic representation of one form of an agent-mediator communication mechanism; and

FIG. 6 is a diagrammatic representation of one form of a distributed data mining method and system.

### DETAILED DESCRIPTION

The methodology presented in this application is concerned with text mining scenarios where data associated with objects are collected at distributed databases. In addition, there is at least one database with structured and one with unstructured data. It is further assumed that data points can be registered across various databases through common keys. In one form, it may be preferable to mine the data across distributed structured and unstructured databases without the need to bring all the data to one central location.

In one form, the method includes Text Categorization, typically a stand-alone application, with a predictive analytics process. Additionally, the method includes the distributed aspect of the predictive analytics process itself, in which a novel distributed decision tree learning algorithm is employed to generate models of data dispersed in various locations without the need to bring all that data to a central location.

The methodology presented in this application is concerned with text mining scenarios where data associated with objects are collected at distributed databases. In addition, in one form, there is at least one database with structured and one with unstructured data. Furthermore, in one form, it can be assumed that data points can be registered across various databases through common keys.

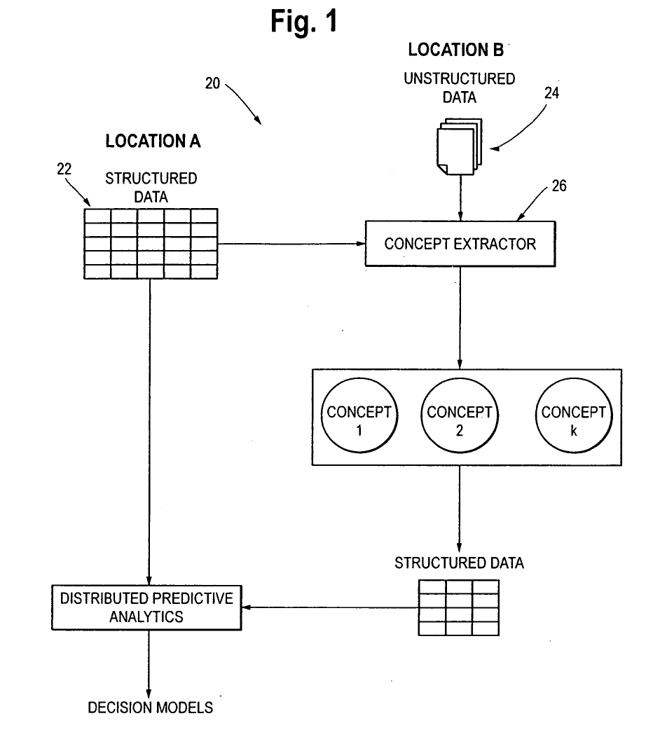

FIG. 1 depicts a high-level view of one form of a text mining method 20. In this form, there is one database 22 with structured data and one database 24 with unstructured data (i.e. a collection of documents). At the heart of the methodology is a Concept Extraction process/concept extractor 26. This, in essence, is a Text Categorization algorithm that builds models of unstructured data, i.e. document collections, based on the labels assigned to them using the annotations specified by the structured data.

However, the aim here is not simply to use Text Categorization to build a set of classifiers for the unstructured data. Rather, the resulting models are used to extract features from the unstructured data to be used in conjunction with the structured data in the mining process (i.e. building classifiers over both structured and unstructured data). The intended features specify the presence or absence of various “concepts” within each class of documents, hence the term Concept Extraction.

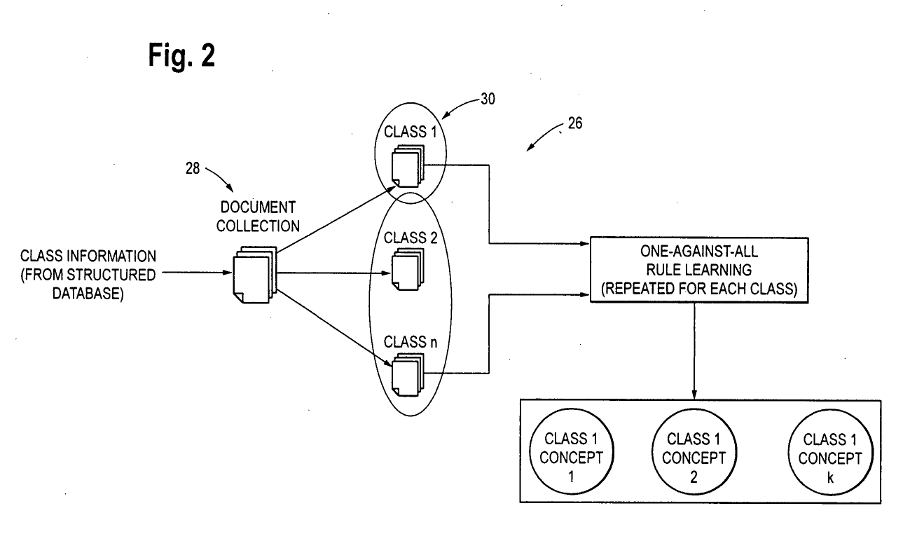

One form of a Concept Extraction process 26 is illustrated in FIG. 2. Documents 28 are first grouped into classes 30 assigned to them, using the class labels of the corresponding data points in the structured data table. Again, the documents 28 and data points in the structured database are registered with common keys. A classifier is then learned for each of these document classes. A rule learning algorithm is employed for this purpose. Each learned rule captures some aspect of the document class. In other words, each rule identifies the various “concepts” present in the class. The presence or absence of such concepts in documents can then be used as features to populate a structured database table.

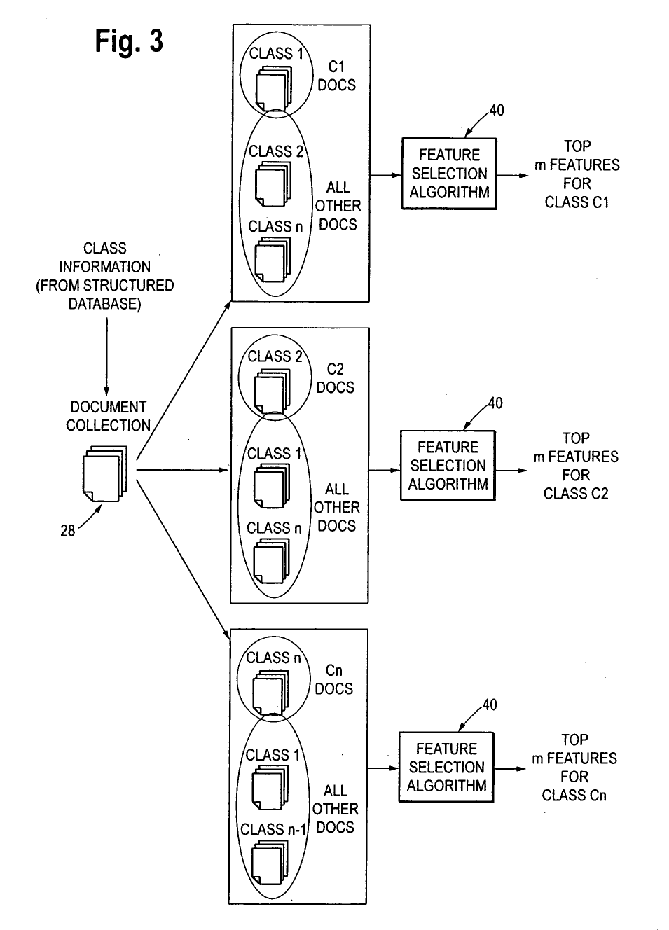

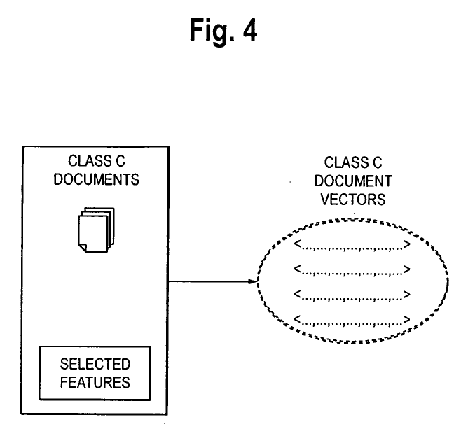

Documents of course must first be converted to a representation suitable for use by a learning algorithm, in this case the rule learner. A popular form of representation, namely that of vector space, has been utilized for this purpose. Here, each document in a given class is represented in terms of a vector of top m features. The top features (i.e. terms) are those with the highest calculated fitness measure (e.g., Information Gain), as determined by a Feature Selection algorithm 40. This process is depicted in FIG. 3. Once the top m features for each document class have been identified, each document is re-represented in terms of a numeric vector indicating the presence or absence of each of the features, such as shown in FIG. 4.

A structured table populated by “concept” based features extracted from unstructured data is used to facilitate data mining across structured and unstructured databases. This is achieved through the use of a distributed mining algorithm described in the following section.

Distributed Data Mining

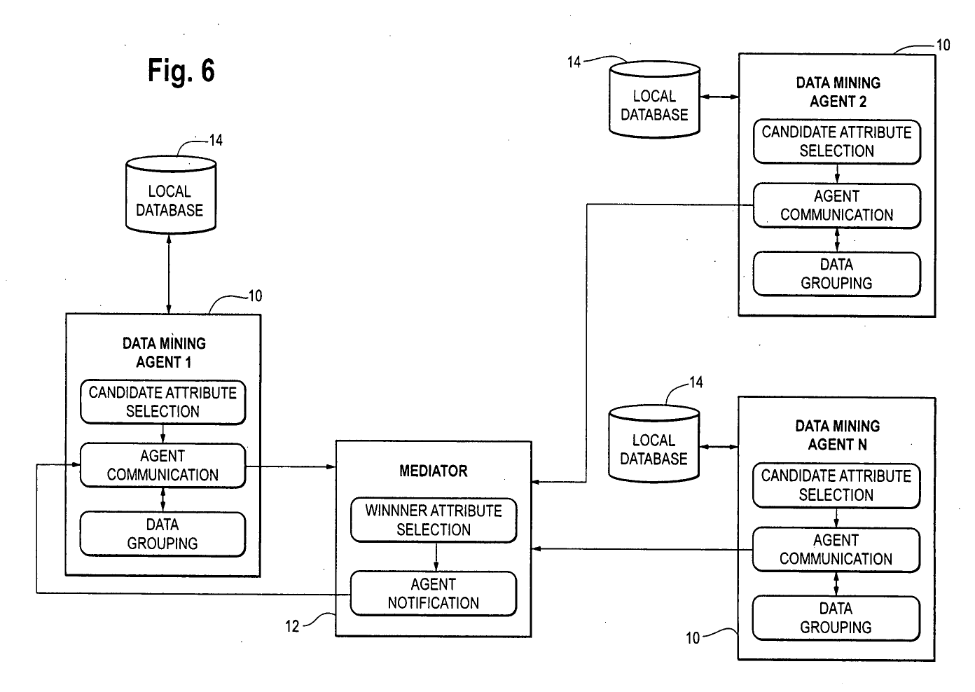

FIG. 6 illustrates one basic form of distributed data mining. Distributed mining is accomplished via a synchronized collaboration of agents 10 as well as a mediator component 12. (see Hadjarian A., Baik, S., Bala J., Manthorne C. (2001) “InferAgent—A Decision Tree Induction From Distributed Data Algorithm,” 5th World Multiconference on Systemics, Cybernetics and Informatics (SCI 2001) and 7th International Conference on Information Systems Analysis and Synthesis (ISAS 2001), Orlando, Fla.). The mediator component 12 facilitates the communication among agents 10. In one form, each agent 10 has access to its own local database 14 and is responsible for mining the data contained by the database 14.

Distributed data mining results in a set of rules generated through a tree induction algorithm. The tree induction algorithm, in an iterative fashion, determines the feature which is most discriminatory and then it dichotomizes (splits) the data into classes categorized by this feature. The next significant feature of each of the subsets is then used to further partition them and the process is repeated recursively until each of the subsets contain only one kind of labeled data. The resulting structure is called a decision tree, where nodes stand for feature discrimination tests, while their exit branches stand for those subclasses of labeled examples satisfying the test. A tree is rewritten to a collection of rules, one for each leaf in the tree. Every path from the root of a tree to a leaf gives one initial rule. The left-hand side of the rule contains all the conditions established by the path, and the right-hand side specifies the classes at the leaf Each such rule is simplified by removing conditions that do not seem helpful for discriminating the nominated class from other classes.

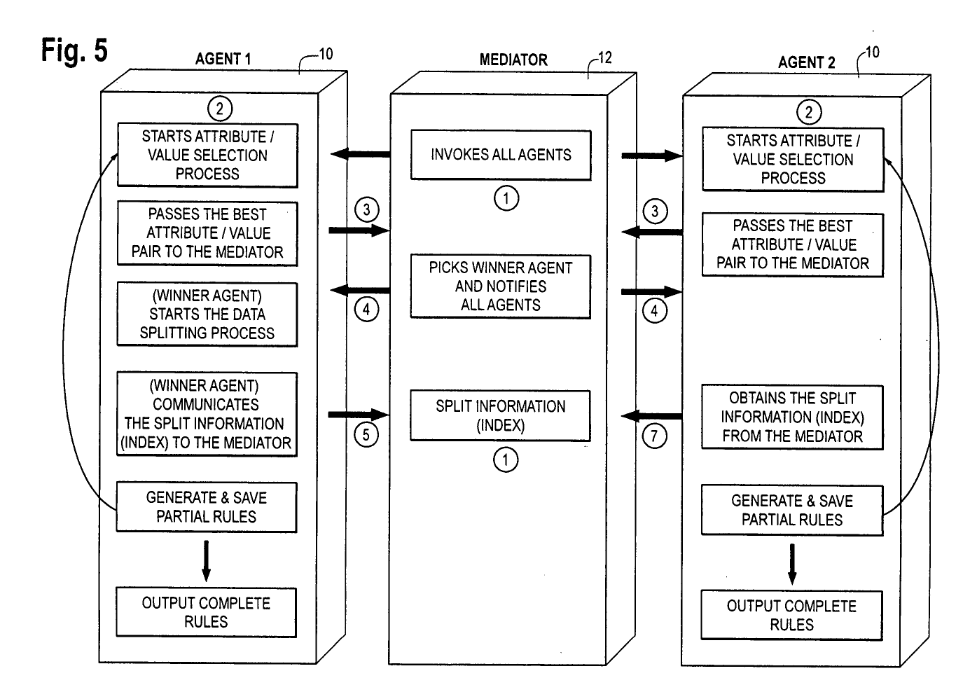

In the distributed framework, tree induction is accomplished through a partial tree generation process and an Agent-Mediator communication mechanism, such as shown in FIG. 5 that executes the following steps:

1. The data mining process starts with the mediator 12 issuing a call to all the agents 10 to start the mining process.

2. Each agent 10 then starts the process of mining its own local data by finding the feature (or attribute) that can best split the data into the various training classes (i.e. the attribute with the highest information gain).

3. The selected attribute is then sent as a candidate attribute to the mediator 12 for overall evaluation.

4. Once the mediator 12 has collected the candidate attributes of all the agents 10, it can then select the attribute with the highest information gain as the winner.

5. The winner agent 10 (i.e. the agent whose database includes the attribute with the highest information gain) will then continue the mining process by splitting the data using the winning attribute and its associated split value. This split results in the formation of two separate clusters of data (i.e. those satisfying the split criteria and those not satisfying it).

6. The associated indices of the data in each cluster are passed to the mediator 12 to be used by all the other agents 10.

7. The other (i.e. non-winner) agents 10 access the index information passed to the mediator 12 by the winner agent 10 and split their data accordingly. The mining process then continues by repeating the process of candidate feature selection by each of the agents 10.

8. Meanwhile, the mediator 12 is generating the classification rules by tracking the attribute/split information coming from the various mining agents 10. The generated rules can then be passed on to the various agents 10 for the purpose of presenting them to the user through advanced 3D visualization techniques.

On exemplary application of one form of the method could be that of customer profiling for an online store. Customer profiling, or modeling of a customer's interests, can facilitate personalized purchase offers and recommendations. An online bookstore, for example, can make book recommendations based on the purchase history of its customers. To do so, the bookstore must first generate a model of a customer's interests.

Customer C has specific interests in modern philosophy and baking. Obviously the bookstore's customer database holds a variety of valuable information on previously purchased items, such as the general topic, price, and the year of publication. However missing from this database is the rich information contained in the textual description of each item. Using this often unstructured textual information in conjunction with the structured data contained in the customer database can potentially yield a more accurate picture of a customer's interests.

The following is an outline of the steps necessary to generate a profile of Customer C using one form of the method:

Step 1—Grouping of documents (i.e. book descriptions) into various categories. Examples of these could be general categories such as “of_interest” and “not_of_interest”. The historical data stored in the customer database can of course facilitate such a grouping. While the descriptions of the books purchased by Customer C in the past can be grouped into the “of_interest” category, descriptions of the items not purchased by this customer (or a sample of them) can be used to populate the “not_of_interest” category.

Step 2—Selecting the most discriminatory terms (i.e. keywords) for differentiating between the “of_interest” and “not_of_interest” categories. This is achieved in an automated fashion with a help of a Feature Selection algorithm that uses statistics based measures such as Information Gain.

For this particular customer, the list of selected features for the “of_interest” category could include terms such as: recipe, baking, philosophy, desserts, Sartre, existentialism, French, culinary, German, morality, Nietzsche, and cookbook.

Step 3—Re-representing each document in terms of a numeric vector indicating the presence (e.g., as indicated by a 1) or absence (e.g., as indicated by a 0) of each of the selected terms. In the below illustration for example, Document 1 contains the terms recipe and baking and Document 3 the terms philosophy and existentialism.

vector of selected terms: <recipe, baking, philosophy, desserts, Sartre, existentialism, . . . >

Document 1: <1, 1, 0, 0, 0, 0, . . . >

Document 2: <0, 1, 0, 1, 0, 0, . . . >

Document 3: <0, 0, 1, 0, 0, 1, . . . >

. . .

Step 4—Learning rule-based models of each category of documents using the above vector space representation. A rule learning algorithm is used for this purpose. Examples of rules generated for the “of_interest” category could include:

Concept 1: if (recipe=1) and (baking=1) then (category=“of_interest”)

Concept 2: if (existentialism=1) then (category=“of_interest”)

. . .

Concept 7: if (desserts=1) and (culinary=1) then (category=“of_interest”)

Step 5—Re-representing each document, this time in terms of a numeric vector indicating whether the document can be classified as belonging to a given category using the generated rules for that category and if so which concept (i.e. learned rule) is satisfied by that document. For example the following vectors indicate that Document 2 belongs to the “of_interest” category and satisfies Concept 7 (i.e., has the terms desserts and culinary) and Document 12 belongs to the “not_of_interest” category.

category vector: <of_interest, not_of_interest>

Document 1: <1, 0>

Document 2: <7, 0>

Document 3: <2,0>

Document 12: <0, 1>

Step 6—Populating a structured database with the above concept vector representation of documents and using this database in conjunction with other existing structured customer databases to generate models of Customer C's interests. This is facilitated by a distributed predictive analytics method as shown in FIGS. 5 and 6. An example of a generated rule-based model for an item to be recommended to Customer C could include the following:

if (years_since_publication<3) and (price<20) and (of_interest=7) then (recommend=yes)

This rules indicates that the user might be interested in books published in the last three years, with a price tag of less than $20 and dealing with the concept of (desserts and culinary).

It should be appreciated that the above example is an application of one form of the present method and system. It should be understood that variations of the method are also contemplated as understood by those skilled in the art. Furthermore, it should be understood that the methods described herein may be embodied in a system, such as a computer, network and the like as understood by those skilled in the art. The system may include one or more processing units, hard drives, RAM, ROM, other forms of memory and other associated structure and features as understood by those skilled in the art. It should be understood that multiple processing units may be used in the system such that one processing units performs certain functions at one data locale, a second processing unit performs certain functions at a second data locale and a third processing unit acts as a mediator.

The matter set forth in the foregoing description and accompanying drawings is offered by way of illustration only and not as a limitation. While particular embodiments have been shown and described, it will be obvious to those skilled in the art that changes and modifications may be made without departing from the broader aspects of applicants' contribution. The actual scope of the protection sought is intended to be defined in the following claims when viewed in their proper perspective based on the prior art.

1. A method for prediction analysis using text categorization, the method comprising the steps of:
grouping a plurality of text documents into a plurality of classes;
selecting a top m most discriminatory terms for each class of documents using statistical based measures;
determining for each document the presence or absence of each of the discriminatory terms;
learning rule-based models of each class of documents using a rule learning algorithm;
determining, for at least a portion of the plurality of documents, if a given learned rule has been satisfied by each respective document;
creating a database of the rules associated with documents satisfying the rules; and
performing distributed data mining to form a predictive result based on at least a portion of the plurality of documents.

2. The method of claim 1 further comprising the step of representing each document in terms of a numeric vector indicating the presence or absence of the discriminatory terms.

3. The method of claim 1 wherein the plurality of text documents are from an unstructured database.

4. The method of claim 1 further comprising the step of representing each document in terms of a numeric vector indicating whether a learned rule has been satisfied by the document.

5. The method of claim 1 wherein the step of performing data mining includes utilizing a decision tree to form the predictive result.

6. The method of claim 1 wherein the step of performing data mining includes the steps of:
collecting candidate attributes by a mediator from a plurality of agents;
selecting a winning agent;
initiating data splitting by the winning agent;
forwarding split data index information from the winning agent to the mediator;
forwarding the split data index information from the mediator to each of the agents; and
initiating data splitting by each of the agents other than the winning agent.

7. A method for prediction analysis using text categorization, the method comprising the steps of:
providing a structured data table having a plurality of class labels;
grouping a plurality of text documents into classes based on the class labels;
selecting a top m most discriminatory terms having the highest calculated fitness measure for each class of documents;
determining for each document the presence or absence of each of the discriminatory terms;
determining at least one concept for each class, the concept being associated with the respective class;
determining, for at least a portion of the plurality of documents, if a given concept is associated with each respective document;
forming a numeric vector for each document indicating if the document is associated with each respective concept;
creating a structured data table of the vectors; and
performing distributed data mining on the structured data table to form a predictive result.

8. The method of claim 7 further comprising the step of representing each document in terms of a numeric vector indicating the presence or absence of the discriminatory terms.

9. The method of claim 7 wherein the plurality of text documents are from an unstructured database.

10. The method of claim 7 wherein the step of performing data mining includes utilizing a decision tree to form the predictive result.

11. The method of claim 7 wherein the step of performing data mining includes the steps of:
collecting candidate attributes by a mediator from a plurality of agents;
selecting a winning agent;
initiating data splitting by the winning agent;
forwarding split data index information from the winning agent to the mediator;
forwarding the split data index information from the mediator to each of the agents; and
initiating data splitting by each of the agents other than the winning agent.

12. A method for prediction analysis using text categorization, the method comprising the steps of:
providing a structured data table having a plurality of class labels;
grouping a plurality of text documents into classes based on the class labels;
selecting a top m most discriminatory terms having the highest calculated fitness measure for each class of documents;
determining for each document the presence or absence of each of the discriminatory terms;
determining a concept for each class, the concept being associated with the respective class;
determining, for at least a portion of the plurality of documents, if a given concept is associated with each respective document;
creating a database of the concepts and the associated documents; and
performing distributed data mining on the database to form a predictive result.

13. The method of claim 12 further comprising the step of representing each document in terms of a numeric vector indicating the presence or absence of the discriminatory terms.

14. The method of claim 12 wherein the plurality of text documents are from an unstructured database.

15. The method of claim 12 wherein the step of performing data mining includes utilizing a decision tree to form the predictive result.

16. The method of claim 12 wherein the step of performing data mining includes the steps of:
collecting candidate attributes by a mediator from a plurality of agents;
selecting a winning agent;
initiating data splitting by the winning agent;
forwarding split data index information from the winning agent to the mediator;
forwarding the split data index information from the mediator to each of the agents; and
initiating data splitting by each of the agents other than the winning agent.

17. A system for prediction analysis using text categorization comprising:
at least one memory unit; and
a plurality of processing units, the plurality of processing units grouping a plurality of text documents into a plurality of classes, selecting a top m most discriminatory terms for each class of documents using statistical based measures, determining for each document the presence or absence of each of the discriminatory terms, learning rule-based models of each class of documents using a rule learning algorithm, determining, for at least a portion of the plurality of documents, if a given learned rule has been satisfied by each respective document, creating a database of the rules associated with documents satisfying the rules and performing distributed data mining to form a predictive result based on at least a portion of the plurality of documents.
